(19) United States
(12) Patent Application Publication
(10) Pub. No.: US 2009/0210336 A1
(43) Pub. Date: Aug. 20, 2009

(54) SPOT EQUIVALENT FUTURES

(76) Inventor: Michael H. SANKOWSKI, II, Oak Park, IL (US)

Correspondence Address: KATTEN MUCHIN ROSENMAN LLP;(C/O PATENT ADMINISTRATOR), 2900 K STREET NW, SUITE 200, WASHINGTON, DC, 20007-5118, US

(21) Appl. No.: 12/034,222

(22) Filed: Feb. 20, 2008

(51) Int. Cl. G06Q 40/00

(52) U.S. Cl. 705/37; 705/400

(57) ABSTRACT

A method and system are provided for facilitating trading of a financial derivative contract. The financial derivative contract includes a first currency and a second entity. The first currency is associated with a first underlying interest rate, and the second entity is associated with a second underlying time-dependent value. A price for the financial derivative contract is determined independently of the first underlying interest rate and the second time-dependent value. The determined price is expressed in terms of the first currency. The first underlying interest rate and the second time-dependent value are used to compute a cost of carry, which cost of carry is then periodically paid out as a term of the financial derivative contract. In this manner, a spot equivalent futures market is created without price dependence on the underlying time-dependent variables, and the contract need not have any expiration date. The second entity may be one of a second currency, a commodity, or a predetermined number of shares of a stock.

### BACKGROUND OF THE INVENTION

1. Field of the Invention

The present invention relates to financial markets and derivative forms of financial products. More particularly, the invention relates to a system and method for facilitating trading of currencies as part of a futures contract which ensures that the price of the currencies retain the value of the exchange rate which currently prevails in the market.

2. Related Art

In the financial world, a common type of derivatives contract is a futures contract. A futures contract is a standardized contract for delivery of a commodity, financial instrument, or cash index at a time in the future. The purpose of a futures contract is to provide a consistent and exchange-tradable vehicle for investors and hedgers to easily manage risk. Some of the common features of futures contracts include: Standardized contract specifications, an expiration date, using a clearing house to clear the contracts, low margin requirements due to the financial stability of the clearinghouse, and the cost of carry rolled into the price of the contract.

A typical futures contract will trade at a premium or discount to the actual level of the underlying instrument. This premium or discount is known as the basis, and is the result of the cost of carry. The cost of carry for a futures contract is what it would cost to hold or store the underlying over the length of the contract. Typically, the longer to the expiration of the futures contract, the greater this cost of carry will be. For example, if one were to hold corn in a silo for delivery in a few months, one would have to pay for the storage facilities during that time period. This cost of carry is implicit in the futures contract, that is, it is added to the price of the futures contract, resulting in the basis.

For financial futures, there is a cost of carry involved as well. In the cash currency market, this cost of carry is related to the difference in interest rate levels of the two currencies of the currency pair. A traditional futures contract will have this cost of carry in the price of the contract. For example, a current price in the Chicago Mercantile Exchanges currency future for the March 07 Euro/USD contract is 1.2846, while the cash market is 1.2771. This is a clear example of the cost of carry, where the futures price is significantly different than the spot price due to the cost of carry being included in the price of the contract.

Currently, there are three conventional ways in which commodities are traded on an exchange. First, there are spot markets which are trading cash, or some other regularly valued instrument, for a commodity. Examples of spot markets include U.S. equity markets, such as the New York Stock Exchange or the NASDAQ exchange. Second, there are futures markets, which involve trading cash, or some other regularly valued instrument, for the future delivery of the product. Examples of futures markets include commodity futures markets, such as the Chicago Mercantile Exchange (CME) or the New York Board of Trade (NYBOT). Third, there are difference markets, which involve trading cash, or some other regularly valued instrument, in return for the right to receive or pay the difference between a mutually agreed-upon price and a price at a future time. Examples of difference markets are known to occur on certain foreign exchanges, such as the Tokyo Stock Exchange. If a difference market renews its contracts every day until a trader cancels the contract, then the market is known as a rolling spot market. Rolling spot markets are typically unregulated and known to occur on foreign exchanges.

### SUMMARY OF THE INVENTION

In one aspect, the invention provides a method for pricing a financial derivative contract for trading on an open market. The financial derivative contract relates to an exchange of a first currency and a second entity. The first currency is associated with a first underlying interest rate and the second entity is associated with a second underlying time-dependent value. The method comprises the steps of: determining a settlement price for the financial derivative contract independently of the first underlying interest rate and the second time-dependent value, the determined price being expressed in terms of the first currency; using the first underlying interest rate and the second time-dependent value to compute a cost of carry; and including a periodic payout of the cost of carry as a term of the financial derivative contract.

The financial derivative contract may have no expiration date. The step of including a periodic payout of the cost of carry may further comprise including a daily payout of the cost of carry as a term of the contract. The second entity may include a second currency. The second underlying time-dependent value may include a second interest rate associated with the second currency. Alternatively, the second entity may include a commodity, a predetermined number of shares of a stock, or an entity having a value that is related to a level of a stock index.

In another aspect, the invention provides a system for facilitating clearing of a financial derivative contract. The system comprises a server at which financial derivative contracts are actively traded; and an interface in communication with the server. The interface is configured to enable at least one of a bid and an offer for the financial derivative contract to be entered. The server is configured to receive bids for the financial derivative contract via the interface. The financial derivative contract relates to a first currency and a second entity. The first currency is associated with a first underlying interest rate and the second entity is associated with a second underlying time-dependent value. A settlement price for the financial derivative contract is determined independently of the first underlying interest rate and the second time-dependent value. The determined settlement price is expressed in terms of the first currency. A cost of carry is computed using the first and second time-dependent values. A periodic payout of the cost of carry is included as a term of the financial derivative contract. The settlement price and the periodic payout of the cost of carry may be separately accounted for.

The financial derivative contract may have no expiration date. The periodic payout of the cost of carry may further comprise a daily payout of the cost of carry. The second entity may include a second currency. The second underlying time-dependent value may include a second interest rate associated with the second currency. Alternatively, the second entity may include a commodity, a predetermined number of shares of a stock, or an entity having a value that is related to a level of a stock index.

In yet another aspect, the invention provides a method for facilitating clearing of a financial derivative contract. The financial derivative contract relates to a first currency and a second entity. The first currency is associated with a first underlying interest rate and the second entity is associated with a second underlying time-dependent value. The method comprises the steps of: offering the financial derivative contract for sale on an exchange at a settlement price; receiving at least one bid to purchase the financial derivative contract; and executing a trade based on the received at least one bid. The settlement price is determined independently of the first underlying interest rate and the second time-dependent value. The settlement price is expressed in terms of the first currency. A cost of carry is computed using the first underlying interest rate and the second time-dependent value. A periodic payout of the cost of carry is included as a term of the financial derivative contract. The settlement price and the periodic payout of the cost of carry may be separately accounted for.

The financial derivative contract may have no expiration date. The periodic payout of the cost of carry may further comprise a daily payout of the cost of carry. The second entity may include a second currency. The second underlying time-dependent value may include a second interest rate associated with the second currency. Alternatively, the second entity may include a commodity, a predetermined number of shares of a stock, or an entity having a value that is related to a level of a stock index.

### BRIEF DESCRIPTION OF THE DRAWINGS

FIG. 1 illustrates a block diagram of a system for facilitating trading of spot equivalent futures contracts according to a preferred embodiment of the invention.

FIG. 2 is a flow chart that illustrates a method of trading spot equivalent futures contracts according to a preferred embodiment of the invention.

FIG. 3 is a flow diagram that illustrates a single exemplary transaction which could result from trading spot equivalent futures contracts according to a preferred embodiment of the invention.

### DETAILED DESCRIPTION OF THE INVENTION

The present invention provides a mechanism to trade, on a futures exchange, contracts which explicitly credit the cost of carry on a daily basis, and thereby track the spot market closely. In a preferred embodiment, this mechanism is referred to as Spot Equivalent Futures, or SEF. Because of the payout of the cost of carry on a daily basis, the SEF contract can be considered to be a perpetual contract, i.e., a contract that has no expiration date.

Accordingly, the present invention differs from a traditional futures contract in two respects: First, the cost of carry is made explicit and is paid out on a daily or regular periodic basis; and second, the contract can be considered to be a perpetual contract that has no expiration date.

The SEF contract accomplishes these objectives by first adjusting margin accounts to the underlying spot market price. By using the underlying spot market price, the SEF contract departs from the conventional futures contract by setting the price based on present value, without regard to the underlying time-dependent variable cost (i.e., for a currency, the corresponding interest rate) that is generally inherent in any futures contract. Secondly, the SEF contract provides a small adjustment to each trader's account every date to account for the differences in interest rates available on each currency. The overall effect of these adjustments is that the price of the SEF contract tracks closely with the underlying spot market price.

Accordingly, in a preferred embodiment of the present invention, a fourth type of market is provided. In the spot equivalent futures market according to a preferred embodiment of the present invention, a trader complies with each of the following:

The trader agrees to pay the difference between a mutually agreed price and the spot market price of some commodity at some time in the future.

The trader clears his/her trades with a licensed clearing organization so neither party assumes credit risk of the other party.

The trader pays the cost of carry from the long party (i.e., the party buying the contract) to the short party (i.e., the party selling the contract) on a regular, periodic basis, typically a daily basis.

The trader agrees to a price as quoted on a regulated exchange.

The trader agrees to keep a fraction of the value/liability of the contract in an account with the exchange (i.e., a margin account). If the trader's margin accounts fall below a certain threshold level, then the exchange will be compelled to sell the trader's assets.

The trader has his/her margin accounts adjusted each day based on the difference between the agreed future price and the current spot price.

Therefore, according to a preferred embodiment of the present invention, the SEF market differs from a conventional spot market in that it receives a commodity only in the future, and also in that it allows margin accounts. The SEF market differs from a conventional futures market in that it pays a dividend based on the cost of carry, and it adjusts margin accounts based on a spot market, rather than on the basis of the futures market itself. The SEF market differs from a conventional difference market in that it does not expire every day, and also in that it is traded on a regulated exchange.

In a preferred embodiment, the cost of carry is provided as a separate charge within the spot equivalent futures contract, in addition to the conventional profit and loss proportion of the contract. For any position held at the end of the trading day, there is a pay/collect for each long or short contract, respective on which way the cost of carry should be paid.

In a preferred embodiment of the invention, a first currency is traded for a second currency, and the cost of carry is computed on the basis of the respective underlying interest rates which are associated with the two currencies. However, the SEF contract may be applied to any type of entity for which futures markets currently conduct trades, such as, for example, a stock, a stock index, or a commodity.

### EXAMPLES

In Tables 1 and 2 below, prices are quote for both of the underlying spot market and the futures market for Euro-US$ exchange rates during a hypothetical two week period. In Table 1, a trader invests $10,000 in the futures market, where the difference in the interest rates between the two currencies (i.e., the swap rate) hovers around 2.3%. In Table 1, the Trading Profit/Loss tracks the futures market and yields a profit of $56.73, based on accumulating profit and loss from changes in the futures market only.

TABLE 1

| | | | | | Account | Swap | Trading |
|---|---|---|---|---|---|---|---|
| Date | Amount | Future Price | Spot Price | Swap Rate | Balance | P/L | P/L |
| Oct 16 | $10,000 | 1.3438 | 1.3454 | 0.023 | −$10,000 | $0.00 | $0.00 |
| Oct 17 | | 1.3451 | 1.3466 | 0.021 | | $0.00 | $12.86 |
| Oct 18 | | 1.3466 | 1.3492 | 0.021 | | $0.00 | $14.86 |
| Oct 19 | | 1.3392 | 1.3443 | 0.023 | | $0.00 | −$74.14 |
| Oct 20 | | 1.3382 | 1.3383 | 0.023 | | $0.00 | −$10.14 |
| Oct 23 | | 1.3485 | 1.3424 | 0.022 | | $0.00 | $103.58 |
| Oct 24 | | 1.3477 | 1.3456 | 0.023 | | $0.00 | −$8.14 |
| Oct 25 | | 1.3495 | 1.3505 | 0.023 | | $0.00 | $17.86 |
| Oct 26 | −$10,000 | 1.3418 | 1.3476 | 0.025 | $10,056.73 | $0.00 | $56.73 |

In Table 2, the trader invests $10,000 in a Spot Equivalent Future contract according to a preferred embodiment of the present invention. In this example, the trader's account is marked to the spot market instead of the futures market, and there is an explicit additional profit and loss based on the swap rate. This yields a total profit of $56.75 when both the swap profit/loss and trading profit/loss are included.

TABLE 2

| | | | | | Account | Swap | Trading |
|---|---|---|---|---|---|---|---|
| Date | Amount | SEF Price | Spot Price | Swap Rate | Balance | P/L | P/L |
| Oct 16 | $10,000 | 1.3454 | 1.3454 | 0.023 | −$10,000 | $0.00 | $0.00 |
| Oct 17 | | 1.3467 | 1.3466 | 0.021 | | $0.63 | $12.00 |
| Oct 18 | | 1.3492 | 1.3492 | 0.021 | | $0.63 | $26.00 |
| Oct 19 | | 1.3443 | 1.3443 | 0.023 | | $0.63 | −$49.00 |
| Oct 20 | | 1.3385 | 1.3383 | 0.023 | | $0.63 | −$60.00 |
| Oct 23 | | 1.3424 | 1.3424 | 0.022 | | $1.92 | $41.00 |
| Oct 24 | | 1.3456 | 1.3456 | 0.023 | | $0.63 | $32.00 |
| Oct 25 | | 1.3501 | 1.3505 | 0.023 | | $0.63 | $49.00 |
| Oct 26 | −$10,000 | 1.3476 | 1.3476 | 0.025 | $10,056.75 | $5.75 | $51.00 |

It is not surprising that the numbers in Tables 1 and 2 nearly match each other. Futures contracts are valued on the basis of the swap rate and the time to expiry. A spot-equivalent futures contract is designed to mimic the profit and loss of a futures market without using the information of the interest rate properties of the currencies underlying the contract.

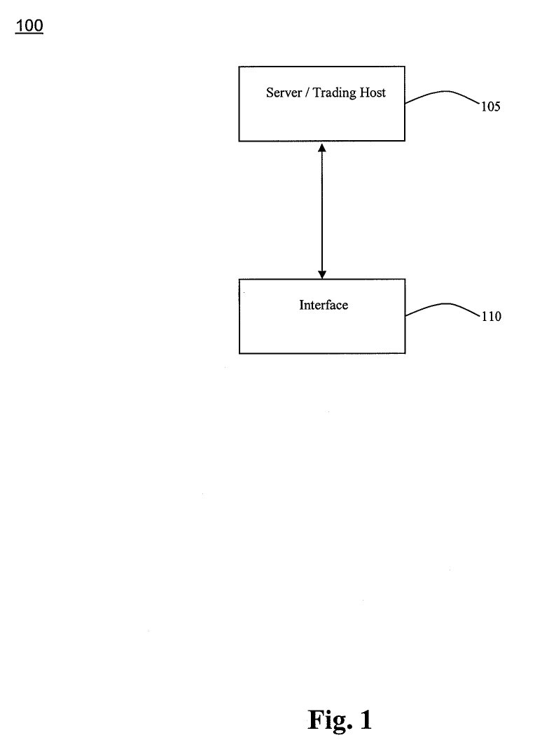

Referring to FIG. 1, a block diagram illustrates an electronic trading system 100 according to a preferred embodiment of the present invention. The system includes one or more servers 105, also referred to as a trading host 105, and one or more interfaces 110. The trading host 105 is preferably implemented by the use of one or more general purpose computers, such as, for example, a Sun Microsystems F15k. Each interface 110 is also preferably implemented by the use of one or more general purpose computers, such as, for example, a typical personal computer manufactured by Dell, Gateway, or Hewlett-Packard. Each of the trading host 105 and the interface 110 can include a microprocessor. The microprocessor can be any type of processor, such as, for example, any type of general purpose microprocessor or microcontroller, a digital signal processing (DSP) processor, an application-specific integrated circuit (ASIC), a programmable read-only memory (PROM), or any combination thereof. The trading host may use its microprocessor to read a computer-readable medium containing software that includes instructions for carrying out one or more of the functions of the trading host 105, as further described below.

Each of the trading host 105 and the interface 110 can also include computer memory, such as, for example, random-access memory (RAM). However, the computer memory of each of the trading host 105 and the interface 110 can be any type of computer memory or any other type of electronic storage medium that is located either internally or externally to the trading host 105 or the interface 110, such as, for example, read-only memory (ROM), compact disc read-only memory (CDROM), electro-optical memory, magneto-optical memory, an erasable programmable read-only memory (EPROM), an electrically-erasable programmable read-only memory (EEPROM), or the like. According to exemplary embodiments, the respective RAM can contain, for example, the operating program for either the trading host 105 or the interface 110. As will be appreciated based on the following description, the RAM can, for example, be programmed using conventional techniques known to those having ordinary skill in the art of computer programming. The actual source code or object code for carrying out the steps of, for example, a computer program can be stored in the RAM. Each of the trading host 105 and the interface 110 can also include a database. The database can be any type of computer database for storing, maintaining, and allowing access to electronic information stored therein. The host server 105 preferably resides on a network, such as a local area network (LAN), a wide area network (WAN), or the Internet. The interface 110 preferably is connected to the network on which the host server resides, thus enabling electronic communications between the trading host 105 and the interface 110 over a communications connection, whether locally or remotely, such as, for example, an Ethernet connection, an RS-232 connection, or the like.

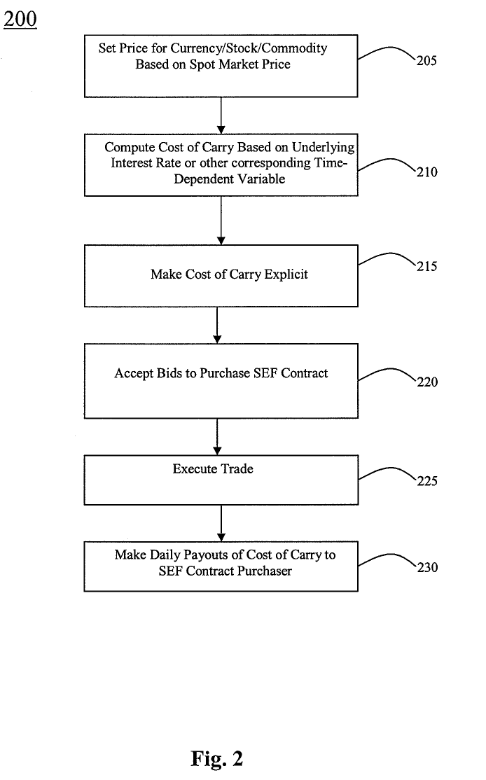

Referring to FIG. 2, a flow chart 200 illustrates a process that is executed by the system 100 for facilitating trading of spot-equivalent futures contracts, according to a preferred embodiment of the present invention. In the first step 205, a price, which is expressed in terms of a first currency, is set by the exchange for a second currency, a quantity of stock or a quantity of a stock index, or a commodity, based only on a spot market price. Then, in step 210, a cost of carry is computed on the basis of the underlying time-dependent variables corresponding to the first currency and the second entity (i.e., the second currency, stock, stock index, or commodity). For example, if the contract includes a first currency and a second currency, then the underlying time-dependent variables may be interest rates whose difference may be expressible as a swap rate, as in the examples shown in Tables 1 and 2. Then, in step 215, the cost of carry is made explicit by the exchange, so that the prospective buyer and seller know the cost of carry. In step 220, the exchange accepts bids to purchase the SEF contract, and then at step 225, a trade is executed. Finally, at step 230, the cost of carry is paid out on a daily basis, typically to the buyer of the SEF contract.

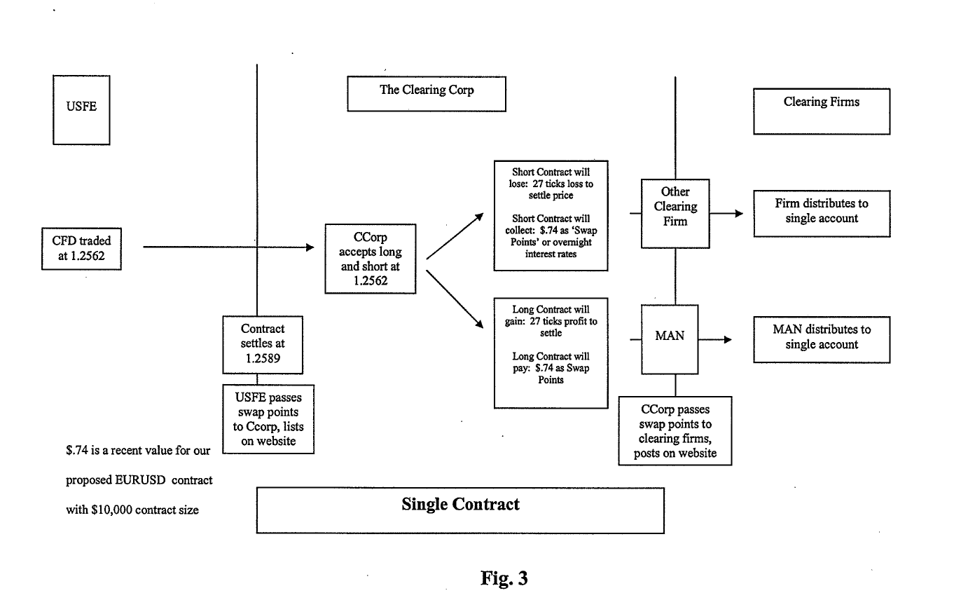

Referring to FIG. 3, a flow diagram is shown which illustrates a single exemplary transaction which could result from trading spot equivalent futures contracts according to a preferred embodiment of the invention. On the left-hand side of the diagram, an exemplary exchange is identified as USFE. The exchange executes a SEF trade at 1.2562. The contract settlement price is set to 1.2589. Moving to the center portion of the flow diagram, because the difference between 1.2562 and 1.2589 is 0.0027, also referred to as 27 ticks, the clearing corporation takes account of this difference by accounting for the 27-tick loss on the side of the short contract (i.e., the seller) to settle the contract, but with a $0.74 collection as “swap points”, which reflects the overnight interest rates, and is therefore the explicit cost of carry. In addition, the clearing corporation also credits the long contract (i.e., the buyer) with a 27-tick gain as part of the contract settlement, but also requires a $0.74 payment of the swap points. Then, moving to the right-hand portion of the flow diagram, the clearing corporation posts the transaction on its web site and passes all of the relevant information to respective clearing firms, which in turn distribute the daily payments and any gains or losses to the corresponding individual accounts.

While the present invention has been described with respect to what is presently considered to be the preferred embodiment, it is to be understood that the invention is not limited to the disclosed embodiments. To the contrary, the invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A method for pricing a financial derivative contract for trading on a market, the financial derivative contract relating to a first currency and a second entity, wherein the first currency is associated with a first underlying interest rate and the second entity is associated with a second underlying time-dependent value, and the method comprising the steps of:
determining a price for the financial derivative contract independently of the first underlying interest rate and the second time-dependent value, the determined price being expressed in terms of the first currency;
using the first underlying interest rate and the second time-dependent value to compute a cost of carry; and
including a periodic payout of the cost of carry as a term of the financial derivative contract.

2. The method of claim 1, wherein the financial derivative contract has no expiration date.

3. The method of claim 1, wherein the step of including a periodic payout of the cost of carry further comprises including a daily payout of the cost of carry.

4. The method of claim 1, wherein the second entity includes a second currency, and the second underlying time-dependent value includes a second interest rate associated with the second currency.

5. The method of claim 1, wherein the second entity includes a commodity.

6. The method of claim 1, wherein the second entity includes a predetermined number of shares of a stock.

7. The method of claim 1, wherein the second entity includes an entity having a value that is related to a level of a stock index.

8. A system for facilitating clearing of a financial derivative contract, the system comprising:
a server at which financial derivative contracts are actively traded; and
an interface in communication with the server, the interface being configured to enable at least one of a bid and an offer for the financial derivative contract to be entered,
wherein the server is configured to receive bids for the financial derivative contract via the interface, and
the financial derivative contract relates to a first currency and a second entity, wherein the first currency is associated with a first underlying interest rate and the second entity is associated with a second underlying time-dependent value, and
wherein a settlement price for the financial derivative contract is determined independently of the first underlying interest rate and the second time-dependent value, the determined settlement price being expressed in terms of the first currency; and
wherein a cost of carry is computed using the first and second time-dependent values; and
wherein a periodic payout of the cost of carry is included as a term of the financial derivative contract.

9. The system of claim 8, wherein the settlement price and the periodic payout of the cost of carry are separately accounted for.

10. The system of claim 8, wherein the financial derivative contract has no expiration date.

11. The system of claim 8, wherein the periodic payout of the cost of carry further comprises a daily payout of the cost of carry.

12. The system of claim 8, wherein the second entity includes a second currency, and the second underlying time-dependent value includes a second interest rate associated with the second currency.

13. The system of claim 8, wherein the second entity includes a commodity.

14. The system of claim 8, wherein the second entity includes a predetermined number of shares of a stock.

15. The system of claim 8, wherein the second entity includes an entity having a value that is related to a level of a stock index.

16. A method for facilitating clearing of a financial derivative contract, the financial derivative contract relating to a first currency and a second entity, wherein the first currency is associated with a first underlying interest rate and the second entity is associated with a second underlying time-dependent value, and the method comprising the steps of:
offering the financial derivative contract for sale on an exchange at a settlement price;
receiving at least one bid to purchase the financial derivative contract; and
executing a trade based on the received at least one bid,
wherein the settlement price is determined independently of the first underlying interest rate and the second time-dependent value, the settlement price being expressed in terms of the first currency; and
wherein a cost of carry is computed using the first underlying interest rate and the second time-dependent value; and
wherein a periodic payout of the cost of carry is included as a term of the financial derivative contract.

17. The method of claim 16, wherein the settlement price and the periodic payout of the cost of carry are separately accounted for.

18. The method of claim 16, wherein the financial derivative contract has no expiration date.

19. The method of claim 16, wherein the periodic payout of the cost of carry further comprises a daily payout of the cost of carry.

20. The method of claim 16, wherein the second entity includes a second currency, and the second underlying time-dependent value includes a second interest rate associated with the second currency.

21. The method of claim 16, wherein the second entity includes a commodity.

22. The method of claim 16, wherein the second entity includes a predetermined number of shares of a stock.

23. The method of claim 16, wherein the second entity includes an entity having a value that is related to a level of a stock index.
